(19) United States
(12) Patent Application Publication
(10) Pub. No.: US 2017/0300871 A1
(43) Pub. Date: Oct. 19, 2017

(54) METHOD AND APPARATUS FOR THE INSTALLATION OF CABLE COMMUNICATION LINES UTILIZING A MOBILE "DROP" APPLICATION

(71) Applicant: Decisive Communications, Inc., Ijamsville, MD (US)

(72) Inventor: Timithy B. Harwood, ljamsville, MD (US)

(73) Assignee: Decisive Communications, Inc., Ijamsville, MD (US)

(21) Appl. No.: 15/446,042

(22) Filed: Mar. 1, 2017

Related U.S. Application Data
(60) Provisional application No. 62/301,921, filed on Mar. 1, 2016.

(51) Int. Cl. G06Q 10/00

(52) U.S. Cl. CPC G06Q 10/20

(57) ABSTRACT

A system and a computer implemented method of assisting a technician during cable communication line installation comprising a memory unit and a processor. The memory unit stores a database comprising one or more records associated with at least one technician and at least one customer, maps of installed cable lines in at least one locality, and a set of program modules. An analyzer module, executed by the processor, is configured to analyze the drop pin path based on feasibility with the plurality of installation parameters and the cable communication line installation job, and notify the at least one technician about the drop pin path, based on the drop pin path being infeasible. A communication module, executed by the processor transmits information regarding the cable communication line installation job to the at least one customer via at least one of an email, a text message, and a voice mail.

### CROSS REFERENCE TO APPLICATION

This patent application claims the benefit of U.S. Provisional Application, App. No. 62/301,921, filed on Mar. 1, 2016. The above application is incorporated by reference herein in its entirety.

### FIELD OF THE INVENTION

The present invention relates to a method and apparatus for the installation of cable communication lines utilizing a mobile “drop” application, and, more particularly, to a method and apparatus that allows for quick and secure communication via mobile devices as between installation/technical teams and the home office in the installation of cable communication lines (for TV and/or phone) as between a communication hub and a home/business.

The present invention also relates to a system and method of assisting a technician during a cable communication line installation process.

### BACKGROUND OF THE INVENTION

Mobile applications have pervaded every aspect of life in the twenty first century. Examples of the on-demand mobile applications include but are not limited to Repair Pal, Uber, and Showaround. Today, users access the on-demand mobile applications for multiple purposes. As often is the case, users access the mobile applications to acquire information about nearby restaurants, lodges, electronics showrooms, and car repair centers. Further, the users access the mobile applications to connect with service providers having expertise in a plurality of fields. Potentially, mobile applications have a wide gamut of practical applications. For example, location detection systems in smart phones like global positioning systems (GPS) can potentially make smart phones useful in labor and time intensive tasks such as, installation of television and telephone cables in a locality. Presently, technicians do initial planning of a cable communication line installation procedure manually because existing state of the art lacks mobile applications designed to assist the technicians during the cable communication line installation process.

Therefore, there is a need in the art for a system and computer implemented method for assisting technicians during the cable communication line installation process.

### SUMMARY OF THE INVENTION

Accordingly, the present invention is directed to providing a system and method of assisting a technician during a cable communication line installation process.

In one embodiment of the present invention, a system of assisting a technician during a cable communication line installation process comprises a memory unit and a processor. The memory unit stores a database comprising one or more records associated with at least one technician and at least one customer, maps of installed cable lines in at least one locality, and a set of program modules. A service request module, executed by the processor, configured to receive a service request for a cable communication line installation job at a property in the at least one locality. A verification module, executed by the processor, is configured to receive a first account number from the at least one technician, compare the first account number with the account number of the at least one customer. The verification module is further configured to notify the at least one technician, based on the first account number being non-identical to the account number of the at least one customer. An input module, executed by the processor, is configured to receive a plurality of installation parameters from the at least one technician, and receive from the at least one technician a drop pin path to install cables. An analyzer module, executed by the processor, is configured to analyze the drop pin path based on feasibility with the plurality of installation parameters and the cable communication line installation job, and notify the at least one technician about the drop pin path, based on the drop pin path being infeasible. A communication module, executed by the processor, is configured to transmit information regarding the cable communication line installation job to the at least one customer via at least one of an email, a text message, and a voice mail.

In one embodiment of the present invention, the one or more records further comprise information regarding permission levels of the at least one technician, maximum installation pins allowed to the at least one technician, maximum footage between installation pins allowed to the at least one technician, billing information of the at least one customer, and address of the at least one customer. In yet another embodiment of the present invention, the maps comprises locations of pedestals in the at least one locality, footage of installed cables in the locality and locations of homes of the at least one customer in the at least one locality. In yet another embodiment of the present invention, the plurality of installation parameters comprises employee identification number of the at least one technician, company identification, location of the technician, address of property, map of temporary above-ground cables, number of road bores required to carry out the installation job, information about private utilities in the property. In yet another embodiment of the present invention, the analyzer module is further configured to receive expenses incurred while performing the installation job, and generate a bill for the at least one customer based on the incurred expenses. In yet another embodiment of the present invention, the input module receives the plurality of installation parameters and the drop pin path via at least one of a touch screen, a microphone, a keyboard, a mouse, and a camera. In yet another embodiment of the present invention, the communication module is configured to display locations of pedestals in the at least one locality.

In one embodiment of the present invention, a computer implemented method of assisting a technician during a cable communication line installation process, comprises storing in a memory unit, a database comprising one or more records associated with at least one technician and at least one customer, maps of installed cable lines in at least one locality, and a set of program modules, wherein the one or more records comprise information regarding account number of the at least one customer. Further, the method comprises receiving at a processor via a service request module, a service request for a cable communication line installation job at a property in the at least one locality. Further, the method comprises receiving at the processor via a verification module, a first account number from the at least one technician. The method comprises comparing at the processor via the verification module, the first account number with the account number of the at least one customer. The method further comprises notifying by the processor via the verification module, the at least one technician based on the first account number being non-identical to the account number of the at least one customer. The method comprises receiving at the processor via an input module, a plurality of installation parameters from the at least one technician. The method comprises receiving at the processor via the input module, from the at least one technician a drop pin path of cables to be installed in the cable communication line installation job. The method further comprises analyzing at the processor via an analyzer module the drop pin path based on extent of feasibility with the plurality of installation parameters and with the cable communication line installation job. The method comprises notifying at the processor via the analyzer module the at least one technician about the drop pin path, based on the drop pin path being infeasible. The method comprises transmitting by the processor via a communication module, information regarding the cable communication line installation job to the at least one customer.

The present invention, including its features and advantages, will become more apparent from the following detailed description with reference to the accompanying drawings.

### BRIEF DESCRIPTION OF DRAWINGS

FIG. 1 is a block diagram of an environment implemented in accordance with various embodiments of the invention.

FIG. 2 is a block diagram of a server, according to an embodiment of the present invention.

FIG. 3 illustrates a screen shot of permissions menu page of the mobile “drop” application initially accessed by the technician and/or field team, according to an embodiment of the present invention.

FIG. 4 illustrates a screen shot of initial start-up page of the mobile “drop” app, according to an embodiment of the present invention.

FIG. 5 illustrates a screen shot of page 2 of the initial page of the mobile “drop” app, according to an embodiment of the present invention.

FIG. 6 illustrates a screen shot of the first page of the selection of the path of the drop of the mobile “drop” app, according to an embodiment of the present invention.

FIG. 7 illustrates a screen shot of a second page of the selection of the path of the drop of the mobile “drop” app, according to an embodiment of the present invention.

FIG. 8 illustrates a screen shot of the zoom-in/out feature page of the mobile “drop” app, according to an embodiment of the present invention.

FIG. 9 illustrates a screen shot of a page showing placement of a drop pin for a Home entry point of the mobile “drop” app, according to an embodiment of the present invention.

FIG. 10 illustrates a screen shot of a page showing placement of a second drop pin for a pedestal point of the mobile “drop” app, according to an embodiment of the present invention.

FIG. 11 illustrates a screen shot of a page showing the options to drop/move and/or delete a drop pin of the mobile “drop” app, according to an embodiment of the present invention.

FIG. 12 illustrates a screen shot of a page showing positioning of the first two drop pins of the mobile “drop” app, according to an embodiment of the present invention.

FIG. 13 illustrates a screen shot of a page showing positioning of a third drop pin of the mobile “drop” app, according to an embodiment of the present invention.

FIG. 14 illustrates a screen shot of a page showing all three drop pins set and having different drop pin icons of the mobile “drop” app, according to an embodiment of the present invention.

FIG. 15 illustrates a screen shot of a page showing overall footage of the drop pin path of the mobile “drop” app, according to an embodiment of the present invention.

FIG. 16 illustrates a screen shot of a page showing completion of the required drop pin path information of the mobile “drop” application page of the mobile “drop” app, according to an embodiment of the present invention.

FIG. 17 illustrates a screen shot of a page showing successful submission of the drop pin path forms of the mobile “drop” app, according to an embodiment of the present invention.

FIG. 18 illustrates a flow chart of a method of assisting a technician during a cable communication line installation process, according to an embodiment of the present invention.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

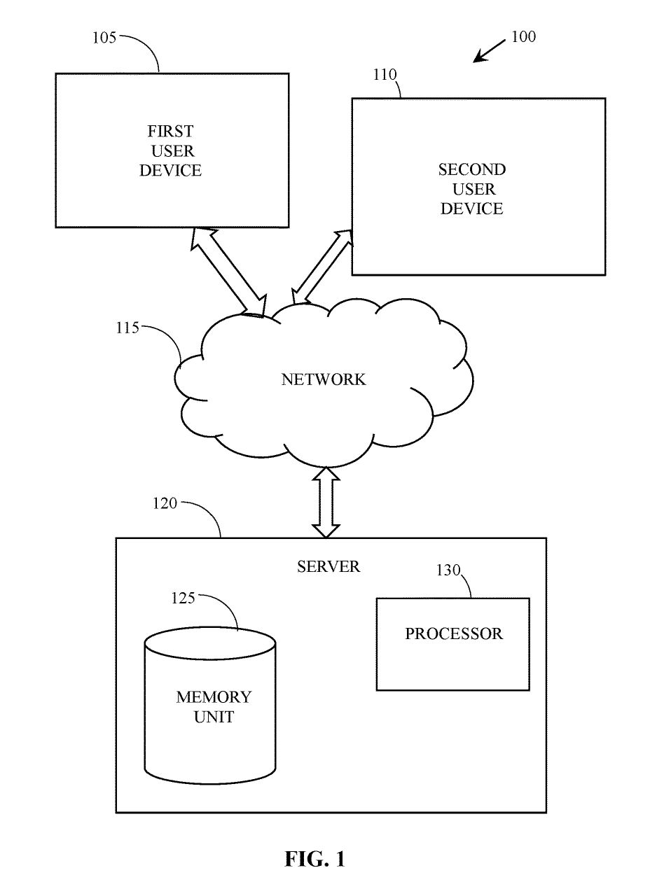

FIGS. 1 through 18 illustrate a method and apparatus that allows for quick and secure communication via mobile devices as between installation/technical teams and the home office in the installation of cable communication lines (for TV and/or phone) as between a communication hub and a home/business. The installation/technical team will have a “drop” app loaded onto their remote/mobile devices.

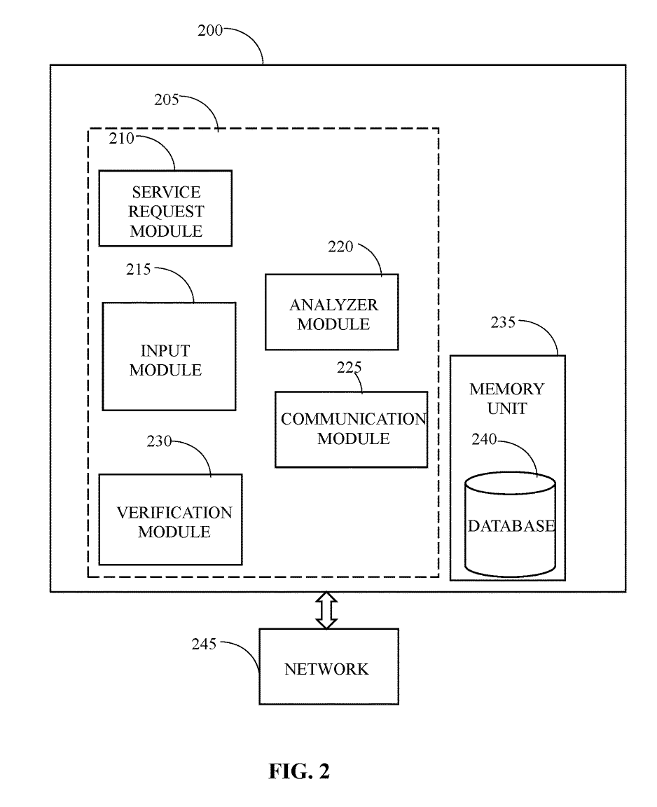

FIG. 1 is a block diagram of an environment 100 implemented in accordance with various embodiments of the invention. The present invention enables quick and secure communication between technicians and a home office of a cable communication line installation firm, during a cable communication line installation process. The cable communication lines are for television, broadband internet, and telephones. The cable communication lines are generally installed between a communication hub and a home/business. The present invention requires the technicians to install a “drop” in mobile phones used by the technicians. The environment 100 comprises a first user device 105, a second user device 110, a network 115, and a server 120. The first user device 105 and the second user device 110 are at least one of tablet computers, personal computers, smart phones, smart televisions and laptops. In one embodiment of the present invention, the first user device 105 and the second user device 110 comprises a Global Positioning System (not shown here). In one example, the first user device 105 enables a user to communicate with the server 120 via the network 115. The first user device 105 and the second user device 110 are at least one of laptops, personal computers, smart phones, smart televisions, and tablet computers. The network 115 is at least one of a mobile network, a Wi-Fi network, and a local area network. The present invention is implemented in at least one of the first user device 105, the second user device 110 and the server 120. In one example, the present invention is implemented in the server 120. A block diagram of an exemplary implementation of the server 120 according to an embodiment is illustrated in FIG. 2.

Referring to FIG. 2, a server 200 comprises a processor 205 and a memory unit 235. The memory unit 235 stores a database 240 comprising one or more records associated with at least one technician and at least one customer, maps of installed cable lines in at least one locality, and a set of program modules. The one or more records further comprise information regarding permission levels of the at least one technician, maximum installation pins allowed to the at least one technician, maximum footage between installation pins allowed to the at least one technician, billing information of the at least one customer, and address of the at least one customer. In yet another embodiment, the maps comprises locations of pedestals in the at least one locality, footage of installed cables in the locality and locations of homes of the at least one customer in the at least one locality. The set of program modules comprise a service request module 210, an input module 215, an analyzer module 220, a communication module 225, and a verification module 230. The set of program modules are executed by the processor 205. The service request module 210 is configured to receive a service request for a cable communication line installation job at a property in the at least one locality. The service request module 210 receives the service request as at least one of an email, a text message, and a voice mail.

Further, the verification module 230 is configured to receive a first account number from the technician, and compare the first account number with the account number of the at least one customer. If the first account number is non-identical to the account number of the at least one customer, then the verification module 230 notifies the technician about mismatch. In one example, the technician enters the first account number by typing on a keypad. If the first account number is non-identical with the account number, then the verification module 230 requests the technician to reenter the first account number typed by the technician on the keypad. If the first account number is still non-identical, then the first account number is manually verified by an agent. If the first account number is identical to the account number of the customer, then the verification module 230 requests the technician to enter address of the customer. Further, the server 200 requests the technician to input installation parameters.

The input module 215 is configured to receive the plurality of installation parameters from the technician. The input module 215 receives the plurality of installation parameters and a drop pin path via at least one of a touch screen, a microphone, a keyboard, a mouse, and a camera. The plurality of installation parameters comprises employee identification number of the at least one technician, company identification, location of the technician, address of property, map of temporary above-ground cables, number of road bores required to carry out the installation job, information about private utilities in the property. Further, the input module 215 receives, the drop pin path to install cables, from the technician. The drop pin path is a proposed plan to install the cable communication lines in the property. The input module 215 transmits the plurality of installation parameters and the drop pin path into the analyzer module 220.

The analyzer module 220 is configured to analyze the drop pin path based on feasibility with the plurality of installation parameters and the cable communication line installation job, and notify the technician about infeasibility of the drop pin path, if the drop pin path is infeasible. The communication module 225, executed by the processor, is configured to transmit information regarding the cable communication line installation job to the at least one customer via at least one of an email, a text message, and a voice mail.

In one example, a technician uploads the plurality of installation parameters, the first account number, and information related to the cable communication line installation job to the input module 215. The input module 215 generates a form based on information received from the technician, and stores the form in the memory unit 235. Further, the input module 215 transmits the form to the communication module 225. The communication module 225 transmits the information to the customer via an email. Further, the communication module 225 enters the information into a digsafe system (not shown). The digsafe system is an internal portal for employees of firms engaged in installing cables. The analyzer module 220 checks the digsafe system multiple time to identify delays in execution of the cable communication line installation job. Further, the analyzer module 220 checks the digsafe system multiple times to verify a locate status of the cable communication line installation job. If the location is verified, then the communication module 225 fires a trigger to assign a contractor for the cable communication line installation job and then transmits details about the contractor to the customer via email. If the cable communication line installation job is delayed, then the communication module 225 identifies a list of companies causing delay in the cable communication line installation job. Further, the communication module 225 transmits the list of companies to the customer. Moreover, the analyzer module 220 is further configured to receive expenses incurred while performing the installation job, and generate a bill for the at least one customer based on the expenses incurred. The communication module 225 is configured to transmits locations of pedestals in the at least one locality to the at least one technician. In one example, the present invention is implemented as a mobile “drop” application. The mobile “drop” application is utilized in two different formats. A first format requires specific information to be populated as it relates to a Serviceability Survey Application for new properties that do not have an existing address within the current billing system. A second format, as it appears within this application, relates to the new installation process whereas the home address currently exists in the billing system as a serviceable address.

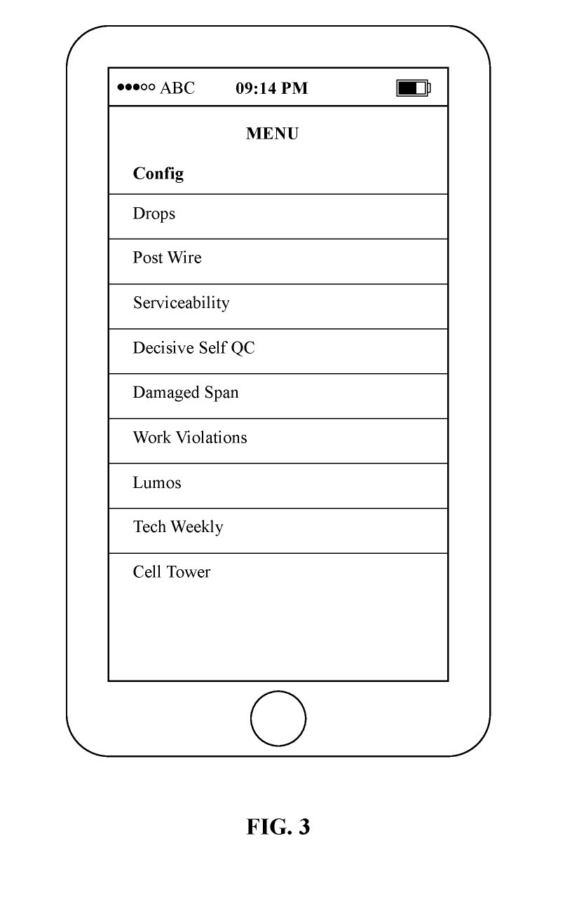

Referring now to FIG. 3, a screen shot of permissions menu page of the mobile “drop” application initially accessed by a technician and/or field team is shown. Permissions for use/access of the various applications (including the first or second format of the mobile “drop” app) are managed in a database by a local administrator. These business suite permissions can be changed dynamically for each technician according to their assigned duties. Once permissions are determined, the technician will only see the apps that are authorized under the technician's set permissions in suite of applications.

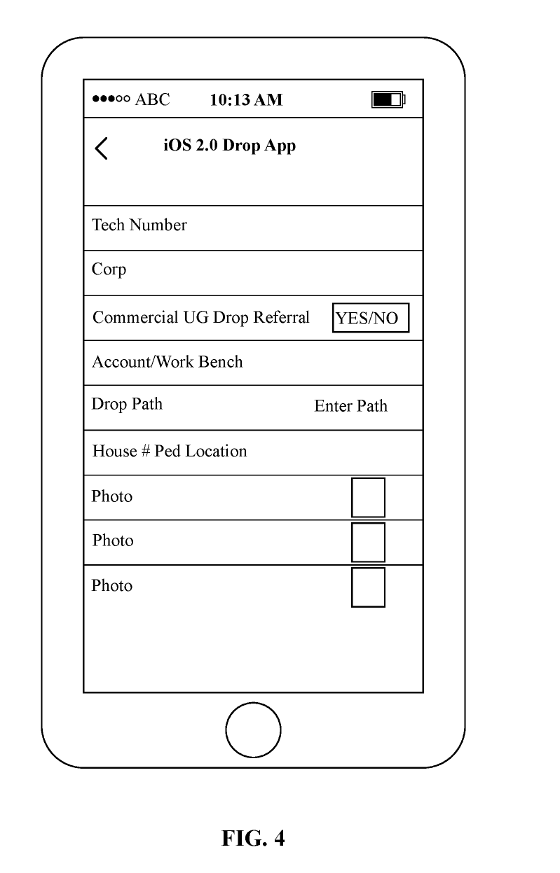

Referring now to FIG. 4, a screen shot of initial start-up page of a mobile “drop” application is shown. In this step, each field of information have to be entered by a technician. However, the mobile “drop” application is developed in order to interface with a billing system information, to reduce user effort. In this particular embodiment, when the technician arrives to install a cable communication line, the cable communication line from a road to a house/business is either not present or it is damaged. As the mobile drop application relates to this functional approach, there is a separate set of required fields as it relates to a cable communication line job. In one example, the data entry fields comprise tech number, corp, commercial UG referral number, drop pin path, house number pedestal location, photos. The tech number receives the employee identification number, which is auto-stored until changed by user. The corp receives the company identification, which is auto-stored until changed by the user. The commercial UG Drop Referral identifies the drop location as a commercial property. Logic changes for length of drop and work bench ID information that is specifically required for Commercial Property. The Drop pin path launches a Map and uses GPS to determine location of the technician. The House # pedestal Location allows the technician to determine the closest house number to the location of the pedestal. The program uses this information to identify Dig Safe System the closest address to the pedestal. This house # is then combined with the GPS Address to write the path verbiage into the dig safe ticket. The Photos activates a camera to attach pictures at the discretion of the technician.

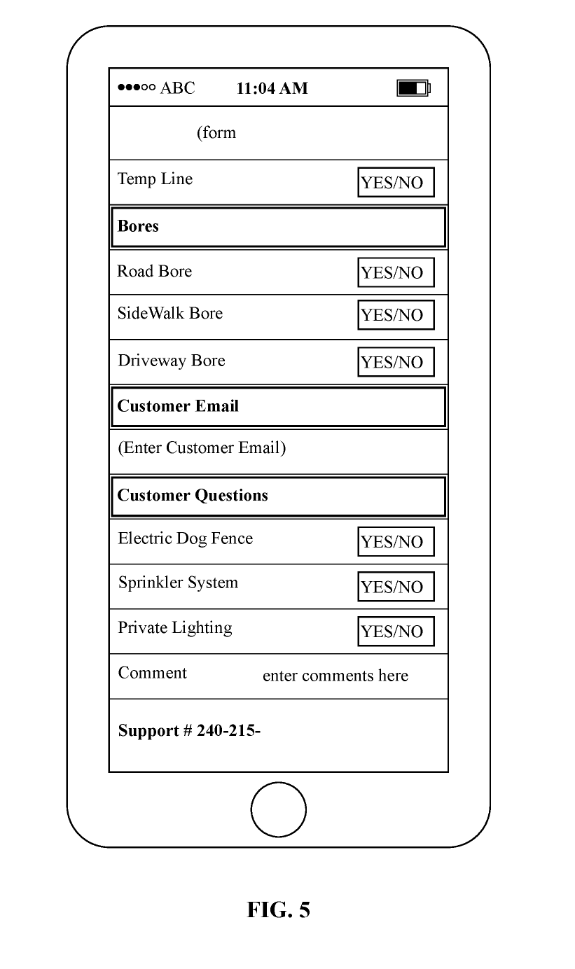

Referring now to FIG. 5, a screen shot of bottom half of the initial page of the mobile “drop” application, which is utilized to convey necessary information to field crews as well as populate information regarding specific property details. A technician uses a scrolling feature of the screens in order to view the bottom half page. The fields in page 2 has to be manually completed by the technician. Information that is collected is conveyed to the field crews as well to the customer at the on-set e-mail trigger point. Such allows the customers to verify information and correct any inaccurate information that has been collected. Such dual information disclosure also allows for reduction of damage to the property during the installation of the underground line. The fields in page 2 comprises a temp line, a road bore, a side walk bore, a drive way bore, a customer email, an electric dog fence, a sprinkler system, a private lighting, a comments, and a support number. The temp line identifies temporary lines on top of ground. This information is used to bury the line and minimize risk by expediting the burial of exposed lines. The road bore specific county permits are required in order to complete the road bores. The present invention uses this information in the backend to isolate cable communication line installation jobs until the permit is processed. The side walk bore and the drive walk bore alerts to type of equipment needed. The customer email informs customer proactively of status of drop burial. The electric dog fence, the sprinkler system, and the private lighting identifies private utilities of the customer.

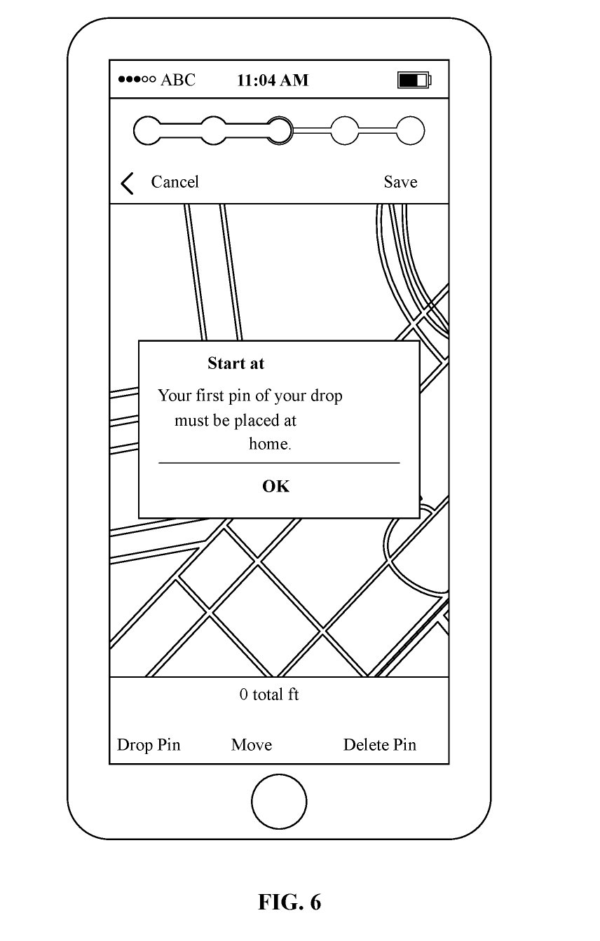

Referring now to FIG. 6, a screen shot of the first page of the selection of a drop pin path is shown. Here, the technician is required to select the drop pin path. The mobile drop application directs the technician to start at a home entry point and then directs the technician to draw the path from the home entry point to the pedestal. The logic within the mobile drop application identifies each pin with an icon of a house for the home pin, pedestal for the pedestal pin, and various pin bubbles for path mid-points. In a preferred embodiment, the technician will have a minimum requirement of 3 pins and a maximum requirement of 4 pins. The technician will see on the map the position of the drop application pins in relationship to each other for ease of use. Footage between the pins is calculated at the bottom of the screen. In a preferred embodiment, if the footage entered reaches a 300 feet maximum threshold, the number turns red and if the technician tries to upload the information exceeding a maximum threshold, the drop entry will be rejected. A rejection message, such as “Upload Failed—Error—Path Length exceeds Maximum Threshold”. The technician will then be prompted to confirm the pin locations, or contact their supervisor.

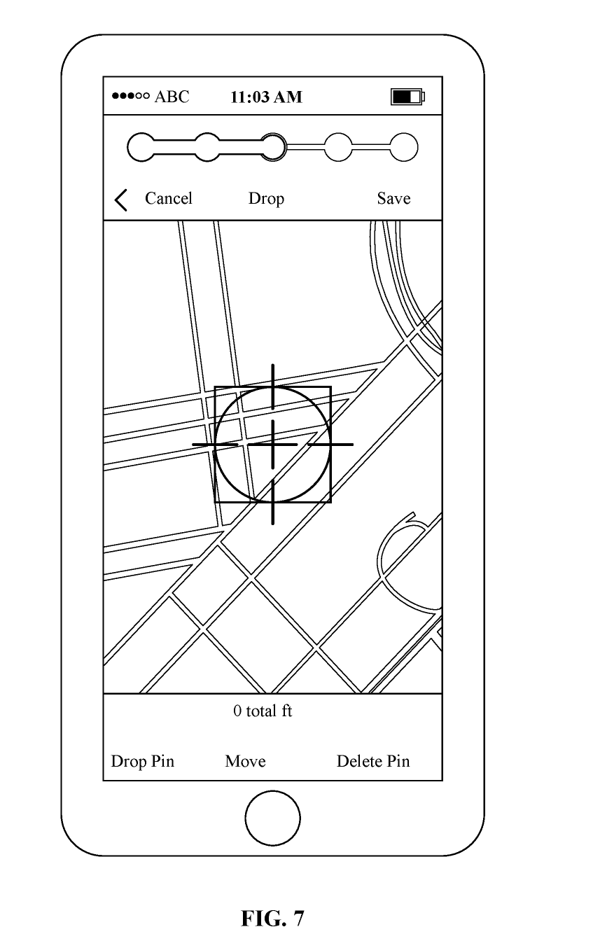

Referring now to FIG. 7, a screen shot a second page of the selection of the path of the drop is shown. In this view a drop pin target will appear in the screen of the mobile device. The technician will move the target until its center has been placed on the map in the desired location of the drop pin. The transparency of the target allows the technician to view the terrain as the map is zoomed in and out. The map should be zoomed in to the lowest altitude above the target are to ensure accurate measurements.

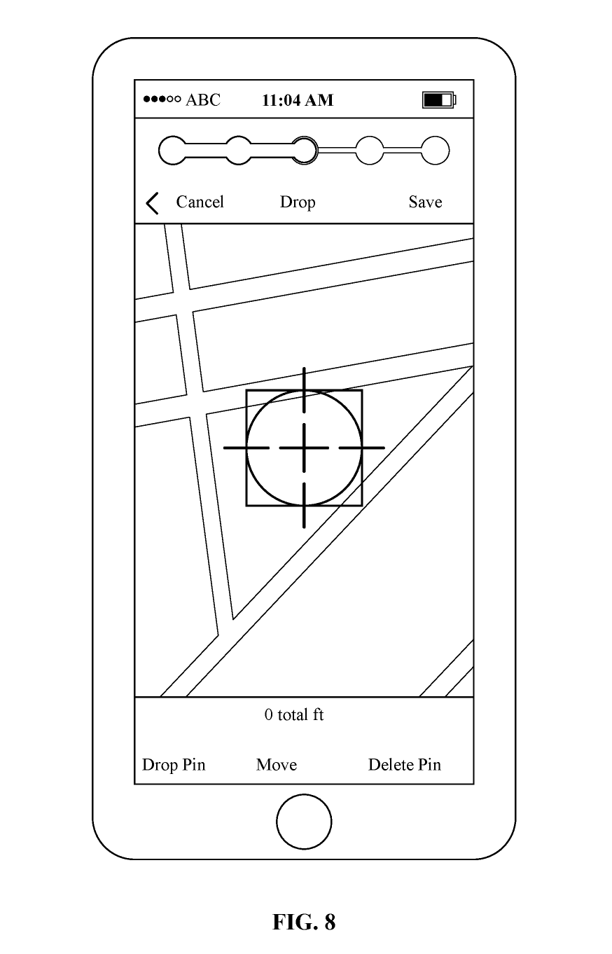

Referring now to FIG. 8, a screen shot of the zoom-in/out feature page is shown. The view on this screen shot demonstrates the ability of the mobile drop application to zoom in/out for the technician with respect to the terrain (mapped area) and allows for the precise placement of the drop pin target over a point in which the pin is to be dropped on the map.

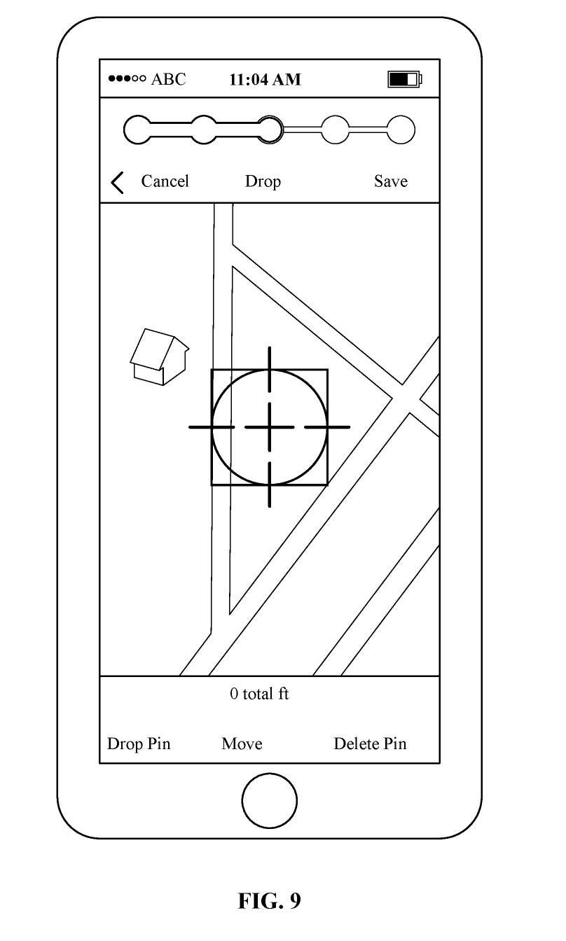

Referring now to FIG. 9, a screen shot of a page showing placement of a drop pin for a Home entry point is shown. In this view, the first pin has been placed at a home/residence. The drop pin icon is a house to indicate to the technician that each icon should be places at the corresponding location on the map. After the first pin information is accepted, the mobile drop application will allow the technician to move to the second drop pin placement point. The technician slides the map under the target until the position of the second drop pin is placed accurately, then chooses the Drop Pin button.

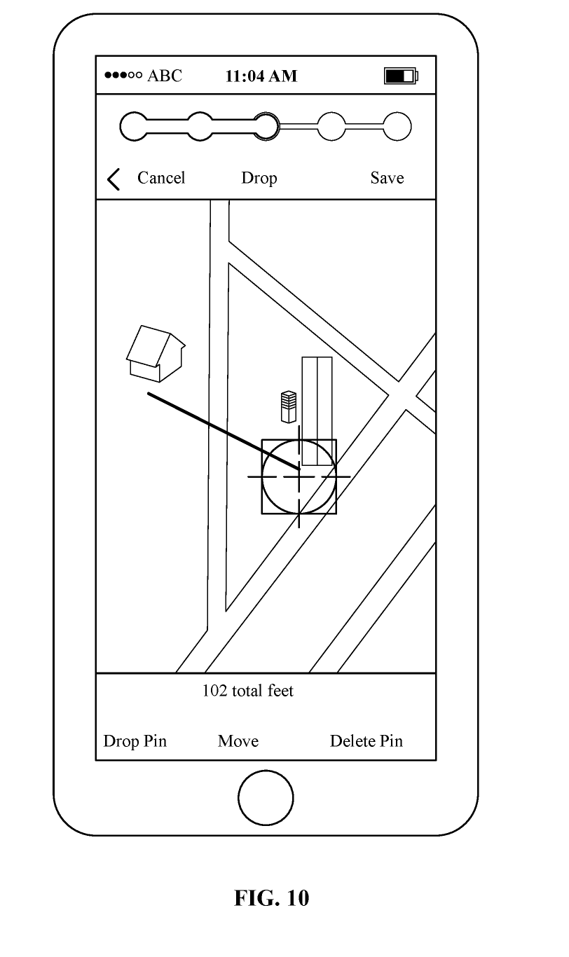

Referring now to FIG. 10, a screen shot of a page showing placement if a second drop pin for a pedestal point is shown. In a preferred embodiment, once the second pin is put into place the path will be highlighted in blue. The Drop Footage will be displayed for the length of the segment at the bottom of the screen. The mobile drop application will automatically calculate the distance between the two drop pins based on the GPS locations of each. The calculations will continue to add for each drop pin added so that the overall distance of the segments can be reflected in the final summary. The pedestal icon continues to display as each drop pin is dropped in place by the technician. The technician will continue to move the target to the new location, once another drop pin is dropped the midpoint pins will automatically be identified within the logic of the drop application as the relationships of the pins change.

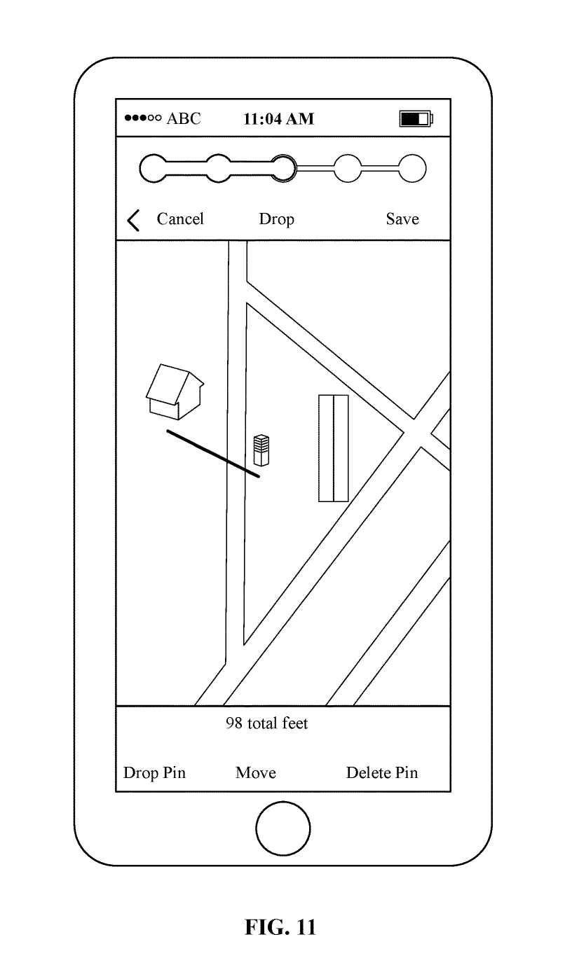

Referring now to FIG. 11, a screen shot of a page showing the options to drop/move and/or delete a drop pin is shown. On this screen of the mobile drop app, the technician has the option to move or delete pins at any point by touching and holding the drop pin to be changed. The target moves to the drop pin that is currently being edited. If the technician deletes the drop pin, then the application will redraw the drop pin path between the remaining pins. Each pin has a direct relationship to another pin on the screen. Such allows for ease of editing and use of the application by the technician.

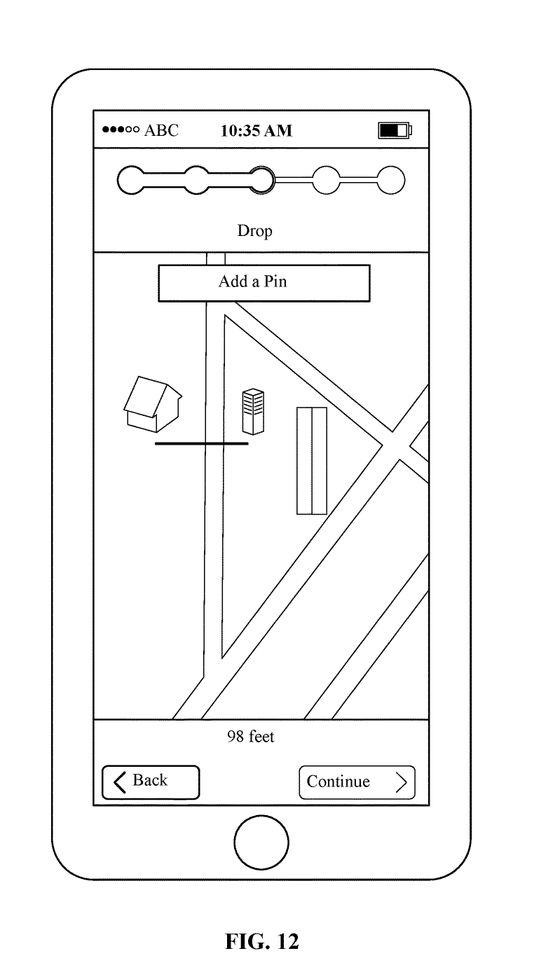

Referring now to FIG. 12, a screen shot of a page showing positioning of the first two drop pins is shown. The technician has successfully positioned the first segment of the drop and is now ready to drop the next pin in the path. The technician cannot continue until all of the requirements for dropping of the pin have been met.

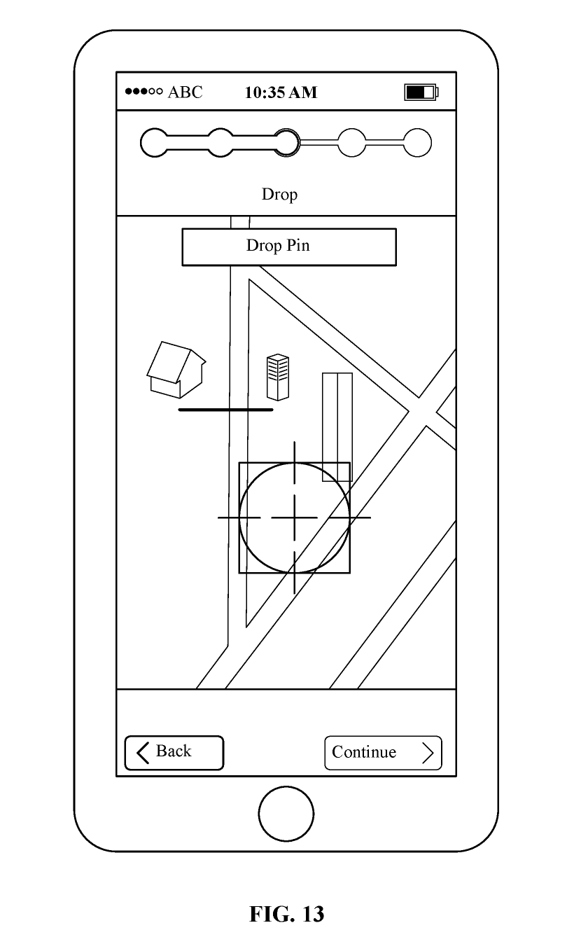

Referring now to FIG. 13, a screen shot of a page showing positioning of a third drop pin is shown. The target will be positioned over the area of the next pin location.

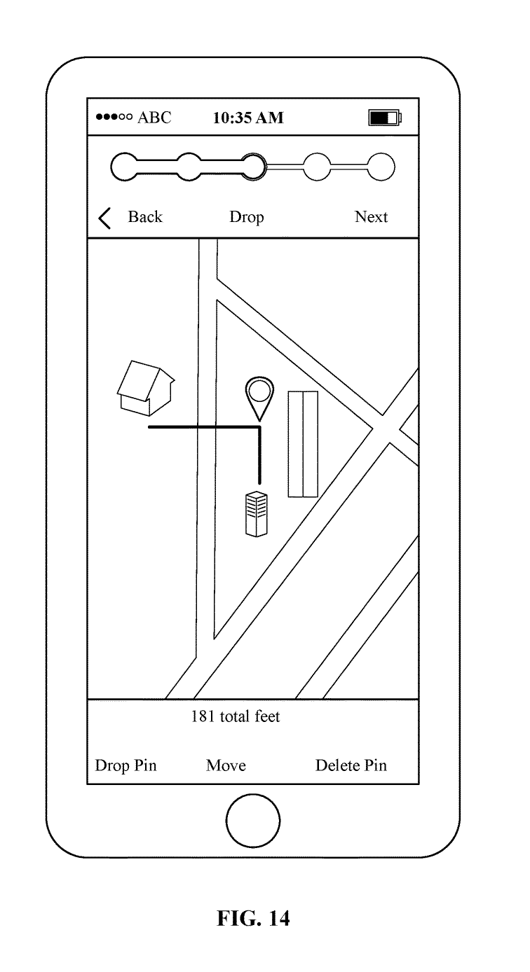

Referring now to FIG. 14, a screen shot of a page showing all three drop pins set and having different drop pin icons is shown. In this embodiment, the technician has now set the third pin. As shown, the screen shot has changed the second pin automatically to a midpoint icon due to the relationship change of the pins thus dropped. If the technician was to set a fourth pin, the pedestal icon would move to the fourth pin and final location and the current third drop pin would change to a midpoint icon. This logic prevents mislabeling that could occur by manual entry of the drop pin labels.

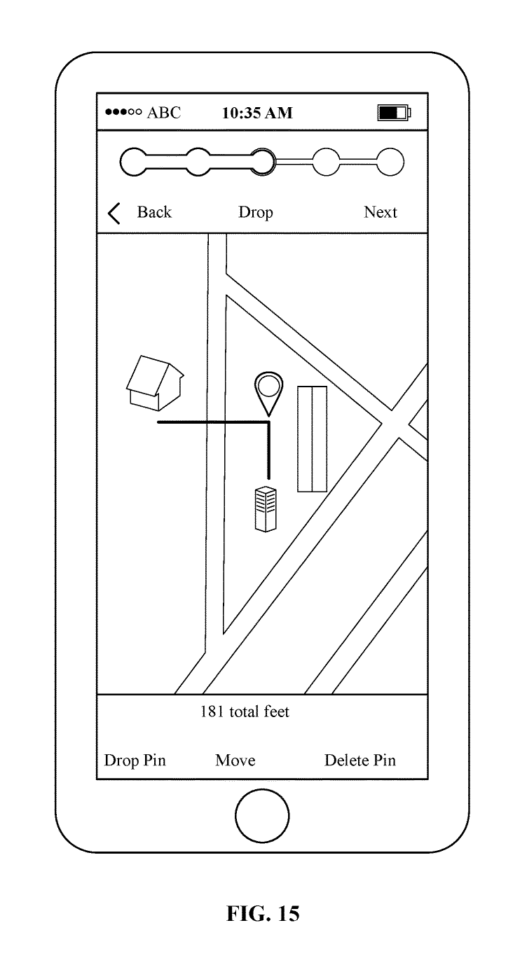

Referring to FIG. 15, a screenshot of a page showing overall footage of the drop pin path is shown. The path is shown per segment. Overall footage is calculated at bottom of the screen for all of the pins. Since all requirements of the drop documentation have been met, the option to edit pins is still available or the user can choose to go back to the form by pressing save. If the calculated footage at the bottom of the screen exceeds 300 feet, it will turn red.

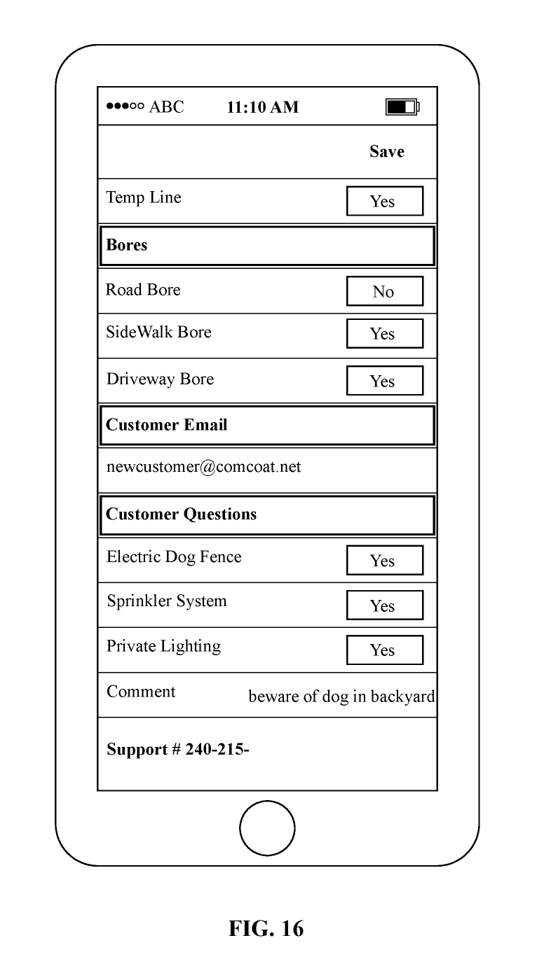

Referring now to FIG. 16, a screen shot of a page showing completion of the required drop path information is shown. Once the user finishes entering the drop path information and presses save. They will be returned to the form to complete. They can continue to scroll through the form to ensure all data is accurate and all information is input according to format.

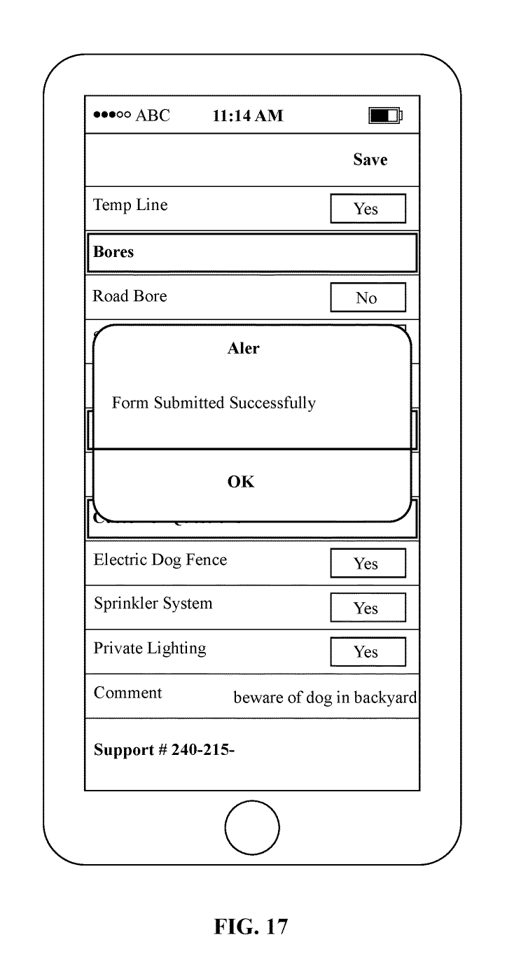

Referring now to FIG. 17, a screen shot of a page showing successful submission of the drop path forms is shown. The user, once submitting the form will be immediately alerted if there are any required fields that have not been completed, any error on the form, and maximum footages are exceeded. The form will direct the user to what is causing the error for correction. If all fields are accepted by the server upon submission, the alert will appear that submission was successful.

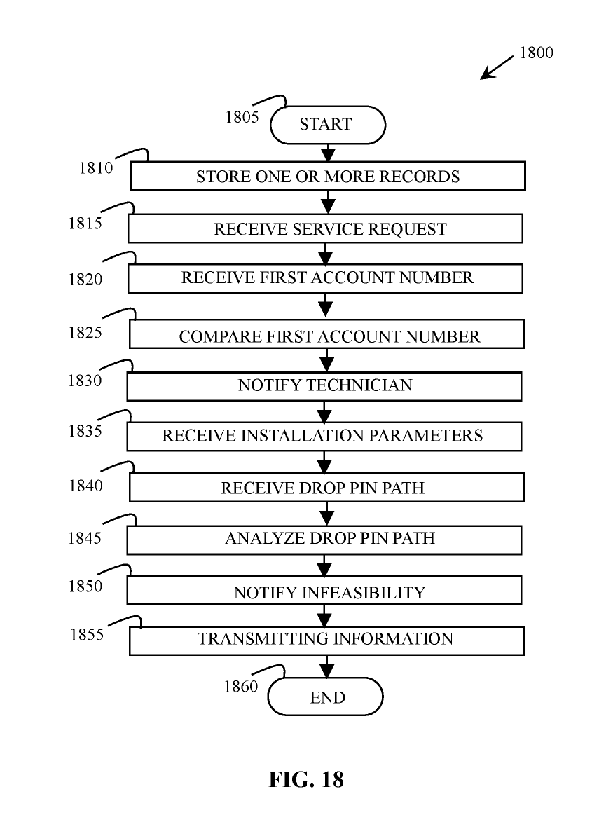

FIG. 18 is a flowchart of a computer-implemented method 1800 of assisting a technician during a cable communication line installation process, in accordance with one embodiment of the present invention. The method 1800 is implemented in a server. The server comprises a processor and a memory unit. The memory unit comprises a database. The method 1800 commences at step 1805.

At step 1810, the database stores one or more records associated with at least one technician and at least one customer, maps of installed cable lines in at least one locality, and a set of program modules. The one or more records further comprise information regarding permission levels of the at least one technician, maximum installation pins allowed to the at least one technician, maximum footage between installation pins allowed to the at least one technician, billing information of the at least one customer, and address of the at least one customer. In yet another embodiment of the present invention, the maps comprises locations of pedestals in the at least one locality, footage of installed cables in the locality and locations of homes of the at least one customer in the at least one locality. The set of program modules comprise a service request module, an input module, an analyzer module, a communication module, and a verification module. The set of program modules are executed by the processor.

At step 1815, the service request module receives a service request for a cable communication line installation job at a property in the at least one locality. The service request module receives the service request as at least one of an email, a text message, and a voice mail.

At step 1820, the verification module receives a first account number from the technician.

At step 1825, the verification module compares the first account number with the account number of the at least one customer.

At step 1830, the verification module notifies the technician of result of the comparison. If the first account number is non-identical to the account number of the at least one customer, then the verification module notifies the technician about mismatch. In one example, the technician enters the first account number by typing on a keypad. If the first account number is non-identical with the account number, then the verification module requests the technician to reenter the first account number typed by the technician on the keypad. If the first account number is still non-identical, then the first account number is manually verified by an agent. If the first account number is identical to the account number of the customer, then the verification module requests the technician to enter address of the customer. Further, the server requests the technician to input installation parameters.

At step 1835, the input module receives the plurality of installation parameters from the technician. The input module receives the plurality of installation parameters and the drop pin path via at least one of a touch screen, a microphone, a keyboard, a mouse, and a camera. The plurality of installation parameters comprises employee identification number of the at least one technician, company identification, location of the technician, address of property, map of temporary above-ground cables, number of road bores required to carry out the installation job, information about private utilities in the property.

At step 1840, the input module receives from the technician, a drop pin path to install cables.

At step 1845, the analyzer module, analyzes the drop pin path based on feasibility with the plurality of installation parameters and the cable communication line installation job.

At step 1850, the analyzer module notifies the at least one technician about feasibility of the drop pin path, based on the drop pin path being infeasible.

At step 1855, the communication module transmits information regarding the cable communication line installation job to the at least one customer via at least one of an email, a text message, and a voice mail. In one example, a technician uploads the plurality of installation parameters, the first account number, and information related to the cable communication line installation job to the input module. The input module generates a form based on information received from the technician, and stores the form in the memory unit. Further, the input module transmits the form to the communication module. The communication module transmits the information to the customer via an email. Further, the communication module enters the information into a digsafe system. The digsafe system is an internal portal for employees of firms engaged in installing cables. The analyzer module checks the digsafe system multiple time to identify delays in execution of the cable communication line installation job. Further, the analyzer module checks the digsafe system multiple times to verify a locate status of the cable communication line installation job. If the location is verified, then the communication module fires a trigger to assign a contractor for the cable communication line installation job and then transmits details about the contractor to the customer via email. If the cable communication line installation job is delayed, then the communication module identifies a list of companies causing delay in the cable communication line installation job. Further, the communication module transmits the list of companies to the customer. Moreover, the analyzer module is further configured to receive expenses incurred while performing the installation job, and generate a bill for the at least one customer based on the expenses incurred. The communication module is configured to transmits locations of pedestals in the at least one locality to the at least one technician. In one example, the present invention is implemented as a mobile “drop” application. The mobile “drop” application is utilized in two different formats. A first format requires specific information to be populated as it relates to a Serviceability Survey Application for new properties that do not have an existing address within the current billing system. A second format, as it appears within this application, relates to the new installation process whereas the home address currently exists in the billing system as a serviceable address.

The method 1800 ends at step 1860.

The foregoing description comprises illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A system for assisting a technician during a cable communication line installation process, the system comprising:
a memory unit to store:
a database comprising one or more records associated with at least one technician and at least one customer, maps of installed cable lines in at least one locality, and a set of program modules,
wherein the one or more records comprise information regarding account number of the at least one customer;
a processor to execute the set of program modules, wherein the set of program modules comprise:
a service request module, executed by the processor, configured to receive a service request for a cable communication line installation job at a property in the at least one locality;
a verification module, executed by the processor, configured to:
receive a first account number from the at least one technician,
compare the first account number with the account number of the at least one customer, and
notify the at least one technician, based on the first account number being non-identical to the account number of the at least one customer;
an input module, executed by the processor, configured to:
receive a plurality of installation parameters from the at least one technician, and
receive from the at least one technician a drop pin path to install cables;
an analyzer module, executed by the processor, configured to:
analyze the drop pin path to calculate on extent of feasibility of the drop pin path with the plurality of installation parameters and the cable communication line installation job, and
notify the at least one technician about infeasibility of the drop pin path, based on the drop pin path being infeasible; and
a communication module, executed by the processor, configured to transmit information regarding the cable communication line installation job to the at least one customer via at least one of an email, a text message, and a voice mail.

2. The system of claim 1, wherein the one or more records further comprise information regarding permission levels of the at least one technician, maximum installation pins allowed to the at least one technician, maximum footage between installation pins allowed to the at least one technician, billing information of the at least one customer, and address of the at least one customer.

3. The system of claim 1, wherein the maps comprises locations of pedestals in the at least one locality, footage of installed cables in the locality and locations of homes of the at least one customer in the at least one locality.

4. The system of claim 1, wherein the plurality of installation parameters comprises employee identification number of the at least one technician, company identification, location of the technician, address of property, map of temporary above-ground cables, number of road bores required to carry out the installation job, information about private utilities in the property.

5. The system of claim 1, wherein the analyzer module is further configured to:
receive expenses incurred while performing the installation job, and
generate a bill for the at least one customer based on the expenses incurred.

6. The system of claim 1, wherein the input module receives the plurality of installation parameters and the drop pin path via at least one of a touch screen, a microphone, a keyboard, a mouse, and a camera.

7. The system of claim 1, wherein the communication module is configured to display locations of pedestals in the at least one locality.

8. A computer implemented method of assisting a technician during a cable communication line installation process, the method comprising:
storing in a memory unit, a database comprising one or more records associated with at least one technician and at least one customer, maps of installed cable lines in at least one locality, and a set of program modules, wherein the one or more records comprise information regarding account number of the at least one customer;
receiving, at a processor via a service request module, a service request for a cable communication line installation job at a property in the at least one locality;
receiving, at the processor via a verification module, a first account number from the at least one technician;
comparing, at the processor via the verification module, the first account number with the account number of the at least one customer;
notifying, by the processor via the verification module, the at least one technician based on the first account number being non-identical to the account number of the at least one customer;
receiving, at the processor via an input module, a plurality of installation parameters from the at least one technician;
receiving, at the processor via the input module, from the at least one technician a drop pin path of cables to be installed in the cable communication line installation job;
analyzing, at the processor via an analyzer module the drop pin path to calculate extent of feasibility of the drop pin path with the plurality of installation parameters and with the cable communication line installation job;
notifying, at the processor via the analyzer module the at least one technician about infeasibility of the drop pin path, based on the drop pin path being infeasible; and
transmitting, by the processor via a communication module, information regarding the cable communication line installation job to the at least one customer.

9. The method of claim 8, wherein the one or more records further comprise information regarding permission levels of the at least one technician, maximum installation pins allowed to the at least one technician, maximum footage between installation pins allowed to the at least one technician, billing information of the at least one customer, and address of the at least one customer.

10. The method of claim 8, wherein the maps comprises locations of pedestals in the at least one locality, footage of installed cables in the locality and locations of homes of the at least one customer in the at least one locality.

11. The method of claim 8, wherein the plurality of installation parameters comprises employee identification number of the at least one technician, company identification, location of the technician, address of property, map of temporary above-ground cables, number of road bores required to carry out the installation job, information about private utilities in the property.

12. The method of claim 8, wherein the analyzer module is further configured to:
receive expenses incurred while performing the installation job, and
generate a bill for the at least one customer based on the expenses incurred.

13. The method of claim 8, wherein the input module receives the plurality of installation parameters and the drop pin path via at least one of a touch screen, a microphone, a keyboard, a mouse, and a camera.

14. The system of claim 8, wherein the communication module is configured to display locations of pedestals in the at least one locality.
